(19) United States
(12) Patent Application Publication
(10) Pub. No.: US 2020/0002998 A1
(43) Pub. Date: Jan. 2, 2020

(54) EXTENDABLE WALL-ENCLOSED DOOR FRAME

(71) Applicants: Kuo-Chi WANG, New Taipei City (TW); FORMOSA DOORFRAME TECHNOLOGY CO., LTD., New Taipei City (TW)

(72) Inventor: Kuo-Chi WANG, New Taipei City (TW)

(21) Appl. No.: 16/455,290

(22) Filed: Jun. 27, 2019

(30) Foreign Application Priority Data
Jun. 27, 2018 (TW) 107121983

(51) Int. Cl. E06B 1/60; E06B 1/34; E06B 1/52

(52) U.S. Cl. CPC E06B 1/6061; E06B 1/52; E06B 1/34

(57) ABSTRACT

An extendable wall-enclosed door frame includes: at least one extended decoration board, where an extended decoration board clamping surface of the extended decoration board is provided with an extended decoration board surface tooth buckle, one end of the extended decoration board is provided with an extended decoration board clamping part with a C-shaped groove, an extended decoration board clamping edge of the extended decoration board clamping part is provided with an extended decoration board internal tooth buckle, the external decoration board surface tooth buckle of the external decoration board clamping surface of the external decoration board is clamped with the extended decoration board internal tooth buckle of the extended decoration board clamping edge of the extended decoration board clamping part of the at least one extended decoration board; and a door frame body, where each of two side edges of the door frame body is respectively provided with a door frame body clamping part with a C-shaped groove, a door frame body clamping edge of the door frame body clamping part is provided with a door frame body internal tooth buckle, the extended decoration board surface tooth buckle of the extended decoration board clamping surface of the at least one extended decoration board is clamped with the door frame body internal tooth buckle of the door frame body clamping edge of the door frame body clamping part of the door frame body.

### BACKGROUND

### Technical Field

The present invention relates to the field of building material structures, and in particular, to an extendable wall-enclosed door frame.

### Related Art

Since ancient times, in construction, a door frame is installed while a wall is built simultaneously. In the current construction industry, a later-embedded construction door frame installing technology has become a trend. FIG. 1 is a schematic diagram showing the installation of a conventional later-embedded construction door frame. FIG. 1 is a drawing of the prior art as shown in Taiwan Patent No. I316986 entitled “Construction method for fast fixing door frame after wall has been constructed and product thereof” (corresponding U.S. Pat. No. 7,533,503 B2) invented by the same inventor. That is, after a house building is completely decorated and before the house building is delivered, door frames and door leaves are installed, thereby beautifying the house building and improving the building quality.

With the emphasis on earthquake resistance, fire prevention, environmental protection, noise control, cost, etc. for improving the quality of residing in the house building, the building structure of the house will be changed. For example, considering the requirement for prevention of temperature change, saving space and lightening the building loading, building materials such as hollow bricks occupying much space with heavy weight are not used; and building materials such as light steel frame compartments, white bricks, foamed cement bricks, sintered red bricks or even commonly used wooden compartments are used. The thicknesses of walls formed by these building materials are different and have great differences.

FIG. 2 is a schematic diagram showing an installation mode in which a conventional door frame is adjusted according to the thickness of a wall. Under the condition that the thickness of the wall gradually increases, the length of a connecting arm 122 of an external decoration board 12 in FIG. 2 needs to be increased, that is, an external decoration board 12′ with a longer connecting arm 122′ is adopted, so that the connecting arm 122′ of the external decoration board 12′ can be inserted into a groove 16 in a side edge of a door frame body 14 to be assembled into a door frame 10 to be installed on a wall W.

To adapt to different thicknesses of walls of houses, door frames with different sizes need to be manufactured. For example, if external decoration boards with connecting arms having different lengths are manufactured to meet market needs, the color and texture changes of the surface materials of the door frames (or external decoration boards) are very complex in manufacture, huge inventory pressure is caused by the door frames with various sizes, and manufacturers cannot know the demands of building materials immediately, so that the building materials are difficult to be handled or supplied to the customers and consumers.

FIG. 3 is a schematic diagram showing that a conventional door frame with extended decoration boards is installed on a wall. To solve the foregoing problem, an external decoration board 22 in FIG. 3 has a fixed size, and a right quantity of extended decoration boards are inserted between a door frame body 24 and the external decoration board 22 according to the thickness of a wall W. Taking FIG. 3 as an example, a connecting arm 30 of an extended decoration board 28 is inserted into a groove 26 in the side edge of the door frame body 24, a connecting arm 30′ of an extended decoration board 28′ is inserted into a groove 32 of the extended decoration board 28, and a connecting arm 23 of the external decoration board 22 is inserted into a groove 32′ of the extended decoration board 28′ to be assembled into a door frame 20 to be installed on the wall W.

In FIG. 3, to obtain aesthetic appearance, the surfaces of the extended decoration boards 28 and 28′ or the surface of the external decoration board 22 can be treated by various modes. For example, the surfaces of the extended decoration boards 28 and 28′ or the surface of the external decoration board 22 can be treated by modes of spraying paint, sticking thin rubber, sticking veneer and the like. By virtue of different surface treatment modes, the extended decoration boards 28 and 28′ and the external decoration board 22 have different thicknesses, that is, the connecting arms 30 and 30′ of the extended decoration boards 28 and 28′ and the connecting arm 23 of the external decoration board 22 have different thicknesses, yet the internal diameters of the openings of the groove 26 in the side edge of the door frame body 24 and the grooves 32 and 32′ of the extended decoration boards 28 and 28′ are fixed, so that if the connecting arms 30 and 30′ of the extended decoration boards 28 and 28′ and the connecting arm 23 of the external decoration board 22 with different thicknesses are respectively inserted into the groove 26 in the side edge of the door frame body 24 and the grooves 32 and 32′ of the extended decoration boards 28 and 28′ with fixed internal diameters of openings, the door frame is difficult to assemble or even collapse due to tight inserting, or the assembled door frame is easy to loosen due to loose inserting.

To enhance the assembling stability of the door frame body, the extended decoration board and the external decoration board, the internal surfaces of the grooves of the door frame body and the extended decoration board are respectively provided with internal tooth buckles, and the external surfaces of the connecting arms of the extended decoration board and the external decoration board are respectively provided with surface tooth buckles. As shown in FIG. 2, the internal surface of the groove 16 of the door frame body 14 is provided with an internal tooth buckle 18, the external surface of the connecting arm 122 of the external decoration board 12 is provided with a surface tooth buckle 124, and when the connecting arm 122 of the external decoration board 12 is inserted into the groove 16 in the side edge of the door frame body 14, the surface tooth buckle 124 of the connecting arm 122 of the external decoration board 12 is clamped with the internal tooth buckle 18 of the groove 16 of the door frame body 14 (the inserting part of the external decoration board 12 at the left side, or top, of the door frame 10 in FIG. 2), thereby enhancing the stability of the assembled door frame 10.

However, in FIG. 3, because the surfaces of the extended decoration boards 28 and 28′ and the surface of the external decoration board 22 are treated by modes of spraying paint, sticking thin rubber, sticking veneer and the like, the connecting arms 30 and 30′ of the extended decoration boards 28 and 28′ and the connecting arm 23 of the external decoration board 22 have different thicknesses by virtue of different surface treatment modes. FIG. 4 is a schematic diagram showing that a conventional door frame is actually installed on a wall. Especially, under the condition that the thickness of the connecting arm 23 of the external decoration board 22 in FIG. 3 is greater than the internal diameter of the opening of the groove 26 in the side edge of the door frame body 24, when, as seen in FIG. 4, the connecting arm 122 of the external decoration board 12 is inserted into the groove 16 in the side edge of the door frame body 14, a clamping edge 19 of the door frame body 24 in the groove 26 is expanded and skewed by the connecting arm 122 of the external decoration board 22, and the clamping edge 19 of the door frame body 24 is even broken due to expansion. Consequently, the internal tooth buckle 18 of the clamping edge 19 of the door frame body 24 cannot be tightly clamped with the surface tooth buckle 124 of the connecting arm 122 of the external decoration board 12, and further, the assembled door frame 10 is easy to loosen.

### SUMMARY

In view of the foregoing problems, the present invention is directed to an extendable wall-enclosed door frame. The internal surfaces of grooves of a door frame body and an extended decoration board are respectively provided with internal tooth buckles, the external surfaces of connecting arms of the extended decoration board and an external decoration board are respectively provided with surface tooth buckles, and the internal diameters of concave regions of openings of the grooves of the door frame body and the extended decoration board are greater than the thicknesses of the connecting arms of the extended decoration board and the external decoration board. When the connecting arm of the external decoration board is inserted into the groove of the door frame body, a clamping edge of the door frame body positioned in the groove cannot be expanded and skewed by the connecting arm of the external decoration board, and the surface tooth buckles of the connecting arms of the extended decoration board and the external decoration board are tightly clamped with the internal tooth buckles of the grooves of the door frame body and the extended decoration board respectively, thereby enhancing the stability of the assembled door frame.

A first embodiment of the present invention provides an extendable wall-enclosed door frame, including:

an external decoration board, where an external decoration board clamping surface of the external decoration board is provided with an external decoration board surface tooth buckle;

at least one extended decoration board, where an extended decoration board clamping surface of the extended decoration board is provided with an extended decoration board surface tooth buckle, one end of the extended decoration board is provided with an extended decoration board clamping part with a C-shaped groove, an extended decoration board clamping edge of the extended decoration board clamping part is provided with an extended decoration board internal tooth buckle, and when the external decoration board is inserted into the C-shaped groove of the clamping part of the at least one extended decoration board, the external decoration board surface tooth buckle of the external decoration board clamping surface of the external decoration board is clamped with the extended decoration board internal tooth buckle of the extended decoration board clamping edge of the extended decoration board clamping part of the at least one extended decoration board; and

a door frame body, where each of two side edges of the door frame body is respectively provided with a door frame body clamping part with a C-shaped groove, a door frame body clamping edge of the door frame body clamping part is provided with a door frame body internal tooth buckle, and when the at least one extended decoration board is inserted into the C-shaped groove of the door frame body clamping part of the door frame body, the extended decoration board surface tooth buckle of the extended decoration board clamping surface of the at least one extended decoration board is clamped with the door frame body internal tooth buckle of the door frame body clamping edge of the door frame body clamping part of the door frame body,

the door frame body clamping edge of the door frame body clamping part and the extended decoration board clamping edge of the extended decoration board clamping part have elasticity, the door frame body clamping edge of the door frame body clamping part and the extended decoration board clamping edge of the extended decoration board clamping part are respectively provided with the door frame body internal tooth buckle and the extended decoration board internal tooth buckle in the positions of the openings close to the C-shaped grooves, the door frame body clamping edge of the door frame body clamping part and the extended decoration board clamping edge of the extended decoration board clamping part are respectively provided with a door frame body concave region and an extended decoration board concave region which are inward concave in the positions away from the openings of the C-shaped grooves, the internal diameter of the door frame body clamping part in the position provided with the door frame body concave region in the C-shaped groove is greater than the internal diameter of the door frame body clamping part in the position provided with the door frame body internal tooth buckle in the C-shaped groove, and the internal diameter of the extended decoration board clamping part in the position provided with the extended decoration board concave region in the C-shaped groove is greater than the internal diameter of the extended decoration board clamping part in the position provided with the extended decoration board internal tooth buckle in the C-shaped groove.

A second embodiment of the present invention provides an extendable wall-enclosed door frame, including:

an external decoration board, where an external decoration board clamping surface of the external decoration board is provided with an external decoration board surface tooth buckle; and

a door frame body, where each of two side edges of the door frame body is respectively provided with a door frame body clamping part with a C-shaped groove, a door frame body clamping edge of the door frame body clamping part is provided with a door frame body internal tooth buckle, and when the external decoration board is inserted into the C-shaped groove of the door frame body clamping part of the door frame body, the external decoration board surface tooth buckle of the external decoration board clamping surface of the external decoration board is clamped with the door frame body internal tooth buckle of the door frame body clamping edge of the door frame body clamping part of the door frame body,

the door frame body clamping edge of the door frame body clamping part has elasticity, the door frame body clamping edge of the door frame body clamping part is provided with the door frame body internal tooth buckle in the position of the opening close to the C-shaped groove, the door frame body clamping edge of the door frame body clamping part is provided with a door frame body concave region which is inward concave in the position away from the opening of the C-shaped groove, and the internal diameter of the door frame body clamping part in the position provided with the door frame body concave region in the C-shaped groove is greater than the internal diameter of the door frame body clamping part in the position provided with the door frame body internal tooth buckle in the C-shaped groove.

### BRIEF DESCRIPTION OF THE DRAWINGS

FIG. 1 is a schematic diagram showing the installation of a conventional later-embedded construction door frame;

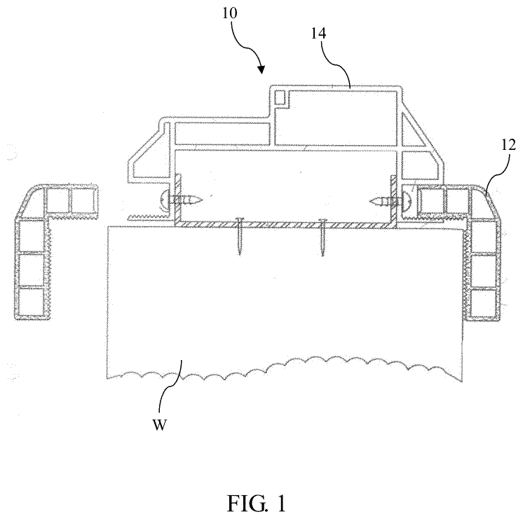

FIG. 2 is a schematic diagram showing an installation mode in which a conventional door frame is adjusted according to the thickness of a wall;

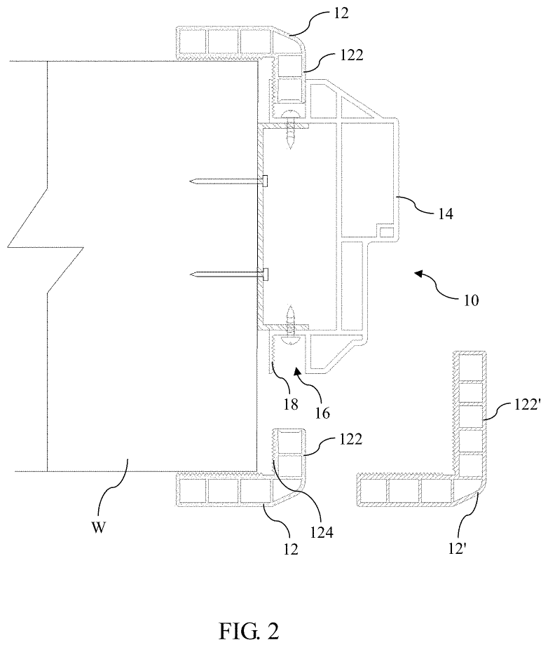

FIG. 3 is a schematic diagram showing that a conventional door frame with extended decoration boards is installed on a wall;

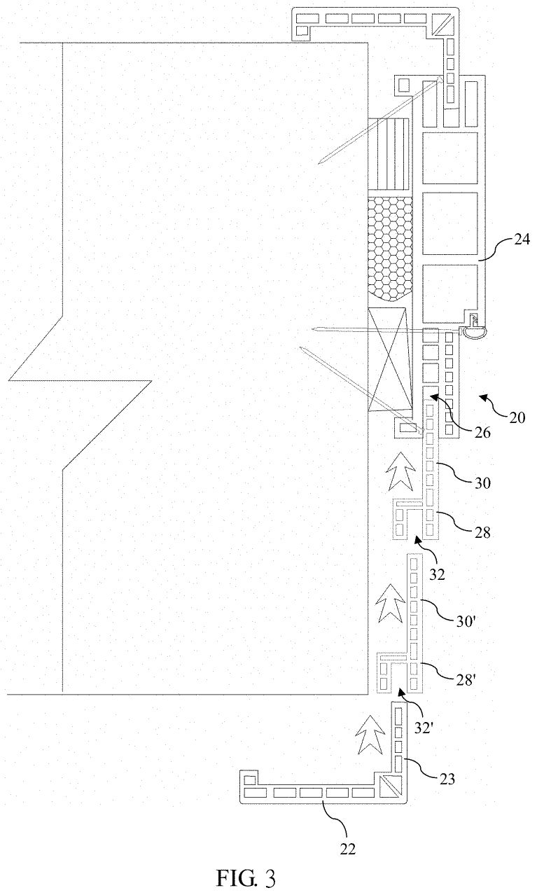

FIG. 4 is a schematic diagram showing that a conventional door frame is actually installed on a wall;

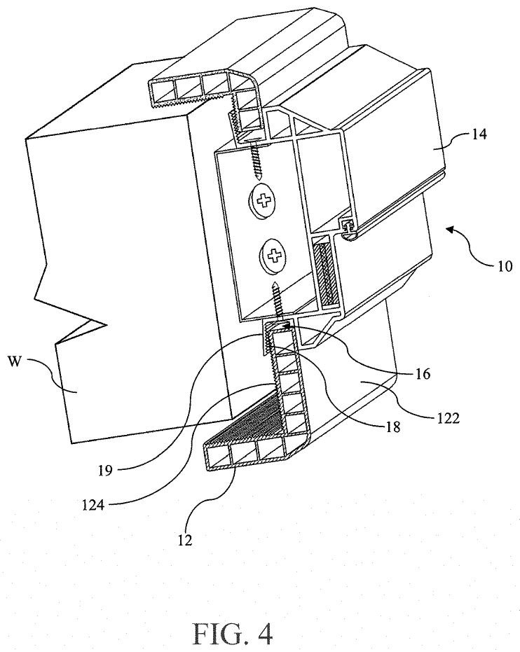

FIG. 5 is a schematic diagram of a door frame combination structure according to a first embodiment of the present invention;

FIG. 6 is a schematic structural diagram of a door frame body according to the first embodiment of the present invention;

FIG. 7 is a schematic structural diagram of an extended decoration board according to the first embodiment of the present invention;

FIG. 8 is a schematic structural diagram of an extended decoration board and an external decoration board according to the first embodiment of the present invention;

FIG. 9 is an exploded view of a door frame combination structure according to a second embodiment of the present invention;

FIG. 10 is a schematic diagram of the door frame combination structure according to the second embodiment of the present invention; and

FIG. 11 is a schematic diagram of a door frame combination structure according to a third embodiment of the present invention.

### DETAILED DESCRIPTION

In order to have a person having ordinary skill in the prior art understand the present invention, the following description with preferred embodiments of the present invention, and with reference to the drawings, describes in detail the constitution of the present invention and efficacy to be achieved.

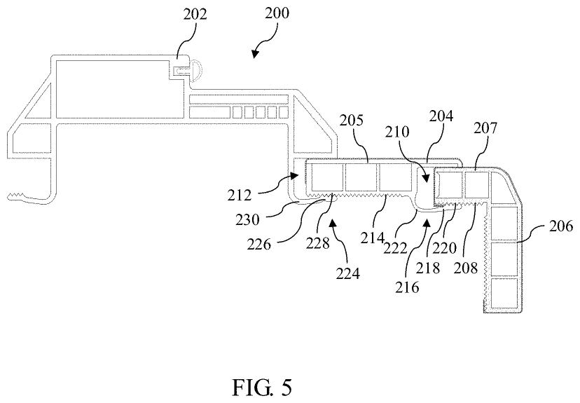

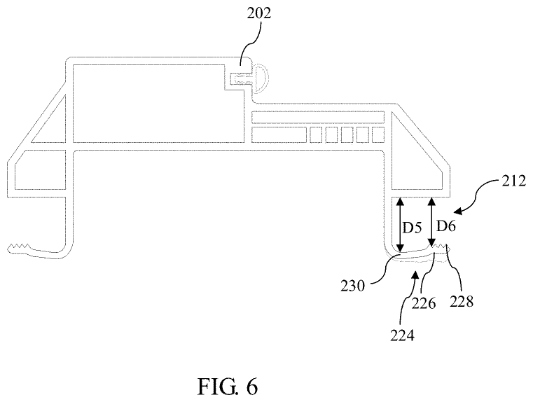

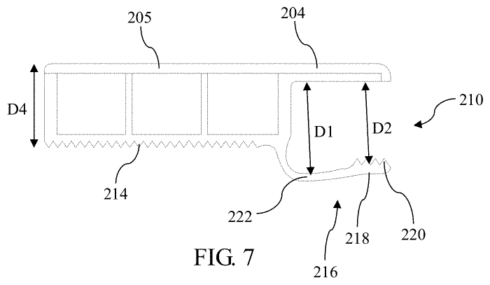

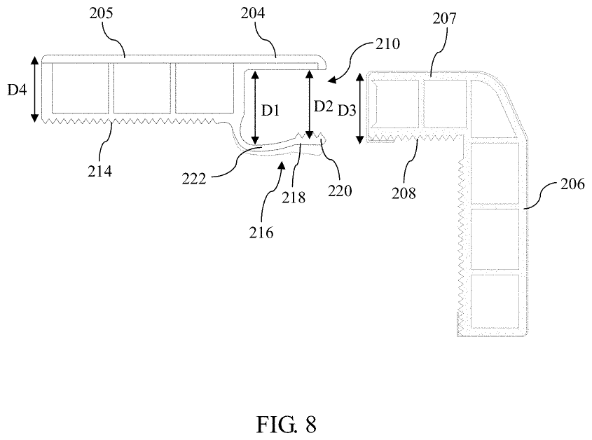

FIG. 5 is a schematic diagram of a door frame combination structure according to a first embodiment of the present invention. FIG. 6 is a schematic structural diagram of a door frame body according to the first embodiment of the present invention. FIG. 7 is a schematic structural diagram of an extended decoration board according to the first embodiment of the present invention. FIG. 8 is a schematic structural diagram of an extended decoration board and an external decoration board according to the first embodiment of the present invention.

In FIG. 5 to FIG. 8, a door frame 200 includes a door frame body 202, an extended decoration board 204 and an external decoration board 206, where a groove in the left side edge of the door frame body 202 in FIG. 5 can also be inserted into the external decoration board and/or the extended decoration board not shown, and the descriptions are omitted herein.

An external decoration board clamping surface of an external decoration board connecting arm 207 of the external decoration board 206 is provided with an external decoration board surface tooth buckle 208, where the external decoration board connecting arm 207 of the external decoration board 206 in FIG. 8 is inserted into the lower surface of a groove 210 in one end of the extended decoration board 204 in a horizontal direction. In FIG. 8, because the surface of the external decoration board 206 is treated by modes of spraying paint, sticking thin rubber, sticking veneer and the like, the thickness D3 of the external decoration board connecting arm 207 of the external decoration board 206 is increased.

An extended decoration board clamping surface of an extended decoration board connecting arm 205 of the extended decoration board 204 is provided with an extended decoration board surface tooth buckle 214, where the extended decoration board connecting arm 205 of the extended decoration board 204 in FIG. 5 is inserted into the lower surface of a groove 212 in the right side edge of the door frame body 202 in a horizontal direction. In FIG. 7, one end of the extended decoration board 204 is provided with an extended decoration board clamping part 216 with a C-shaped groove 210, the internal surface of an extended decoration board clamping edge 218 of the extended decoration board clamping part 216 is provided with an extended decoration board internal tooth buckle 220 in the position of the opening close to the groove 210, and when the external decoration board connecting arm 207 of the external decoration board 206 is inserted into the C-shaped groove 210 of the extended decoration board clamping part 216 of the extended decoration board 204, the external decoration board surface tooth buckle 208 of the external decoration board clamping surface of the external decoration board connecting arm 207 of the external decoration board 206 is clamped with the extended decoration board internal tooth buckle 220 of the extended decoration board clamping edge 218 of the extended decoration board clamping part 216 of the extended decoration board 204.

The extended decoration board clamping edge 218 of the extended decoration board clamping part 216 of the extended decoration board 204 is designed to have elasticity, and the extended decoration board clamping edge 218 of the extended decoration board clamping part 216 is provided with an extended decoration board concave region 222 which is inward concave (downward concave in FIG. 7) in the position away from the opening of the groove 210. In FIG. 7, the internal diameter D1 of the extended decoration board clamping part 216 in the position provided with the extended decoration board concave region 222 in the groove 210 is greater than the internal diameter D2 of the extended decoration board clamping part 216 in the position provided with the extended decoration board internal tooth buckle 220 in the groove 210. Because the surface of the extended decoration board 204 is treated by modes of spraying paint, sticking thin rubber, sticking veneer and the like, the thickness D4 of the extended decoration board connecting arm 205 of the extended decoration board 204 is increased.

In FIG. 8, the internal diameter D1 of the extended decoration board clamping part 216 of the extended decoration board 204 in the position of the extended decoration board concave region 222 of the groove 210 is designed to be equal to or greater than the thickness D3 of the external decoration board connecting arm 207 of the external decoration board 206, and the thickness D3 of the external decoration board connecting arm 207 of the external decoration board 206 is greater than the internal diameter D2 of the extended decoration board clamping part 216 of the extended decoration board 204 in the position provided with the extended decoration board internal tooth buckle 220 in the groove 210. When the external decoration board connecting arm 207 of the external decoration board 206 is inserted into the groove 210 of the extended decoration board 204, because the thickness D3 of the external decoration board connecting arm 207 of the external decoration board 206 is greater than the internal diameter D2 of the groove 210 of the extended decoration board 204, the opening of the extended decoration board clamping edge 218 of the extended decoration board 204 is expanded by the external decoration board connecting arm 207 of the external decoration board 206 (that is, the extended decoration board clamping edge 218 of the extended decoration board 204 in FIG. 8 moves downward). However, the internal diameter D1 of the extended decoration board concave region 222 of the groove 210 of the extended decoration board 204 is equal to or greater than the thickness D3 of the external decoration board connecting arm 207 of the external decoration board 206, and the extended decoration board clamping edge 218 of the extended decoration board clamping part 216 of the extended decoration board 204 has elasticity, so that the extended decoration board clamping edge 218 of the extended decoration board clamping part 216 of the extended decoration board 204 is expanded by one end of the external decoration board connecting arm 207 of the external decoration board 206 but is not downward skewed. Therefore, as shown in FIG. 5, the extended decoration board internal tooth buckle 220 of the extended decoration board clamping edge 218 of the extended decoration board 204 can be tightly clamped with the external decoration board surface tooth buckle 208 of the external decoration board connecting arm 207 of the external decoration board 206.

In FIG. 6, the right side edge of the door frame body 202 is provided with a door frame body clamping part 224 with a C-shaped groove 212 (the left side edge of the door frame body 202 is provided with the same structure and the descriptions are omitted herein), the internal surface of the door frame body clamping edge 226 of the door frame body clamping part 224 is provided with a door frame body internal tooth buckle 228 in the position of the opening close to the groove 212, and when the extended decoration board connecting arm 205 of the extended decoration board 204 is inserted into the C-shaped groove 212 of the door frame body clamping part 224 of the door frame body 202, the extended decoration board surface tooth buckle 214 of the extended decoration board clamping surface of the extended decoration board connecting arm 205 of the extended decoration board 204 is clamped with the door frame body internal tooth buckle 228 of the door frame body clamping edge 226 of the door frame body 202.

The door frame body clamping edge 226 of the door frame body clamping part 224 of the door frame body 202 is designed to have elasticity, and the door frame body clamping edge 226 of the door frame body clamping part 224 is provided with a door frame body concave region 230 which is inward concave (downward concave in FIG. 6) in the position away from the opening of the groove 212. In FIG. 6, the internal diameter D5 of the door frame body clamping part 224 in the position provided with the door frame body concave region 230 in the groove 212 is greater than the internal diameter D6 of the door frame body clamping part 224 in the position provided with the door frame body internal tooth buckle 228 in the groove 212.

In FIG. 6, the internal diameter D5 of the door frame body clamping part 224 of the door frame body 202 in the position of the door frame body concave region 230 of the groove 212 is designed to be equal to or greater than the thickness D4 of the extended decoration board connecting arm 205 of the extended decoration board 204, and the thickness D4 of the extended decoration board connecting arm 205 of the extended decoration board 204 is greater than the internal diameter D6 of the door frame body clamping part 224 of the door frame body 202 in the position provided with the door frame body internal tooth buckle 228 in the groove 212. When the extended decoration board connecting arm 205 of the extended decoration board 204 is inserted into the groove 212 of the door frame body 202, because the thickness D4 of the extended decoration board connecting arm 205 of the extended decoration board 204 is greater than the internal diameter D6 of the groove 212 of the door frame body 202, the opening of the door frame body clamping edge 226 of the door frame body 202 is expanded by the extended decoration board connecting arm 205 of the extended decoration board 204 (that is, the door frame body clamping edge 226 of the door frame body 202 in FIG. 6 moves downward). However, the internal diameter D5 of the door frame body concave region 230 of the groove 212 of the door frame body 202 is equal to or greater than the thickness D4 of the extended decoration board connecting arm 205 of the extended decoration board 204, and the door frame body clamping edge 226 of the door frame body clamping part 224 of the door frame body 202 has elasticity, so that the door frame body clamping edge 226 of the door frame body clamping part 224 of the door frame body 202 is expanded by the extended decoration board connecting arm 205 of the extended decoration board 204 but is not downward skewed. Therefore, as shown in FIG. 5, the door frame body internal tooth buckle 228 of the door frame body clamping edge 226 of the door frame body 202 can be tightly clamped with the extended decoration board surface tooth buckle 214 of the extended decoration board connecting arm 205 of the extended decoration board 204, and the stability of the assembled door frame 200 installed on a wall W is enhanced.

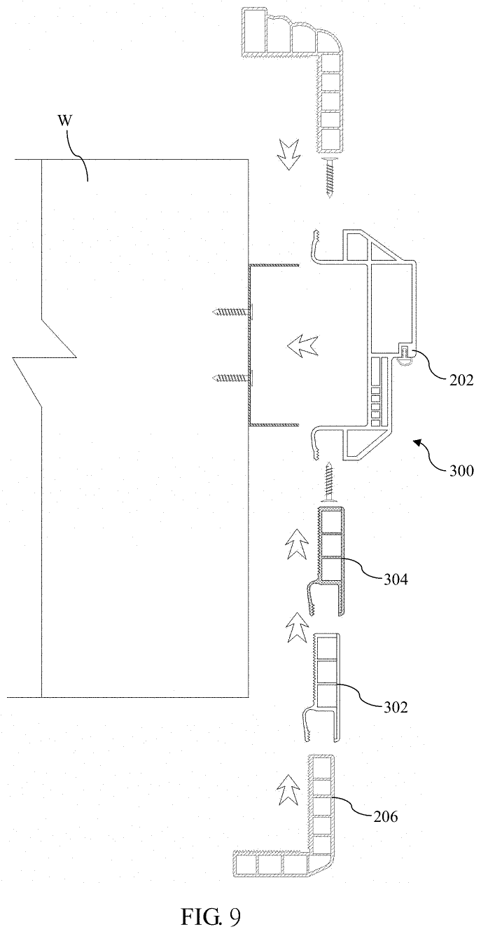

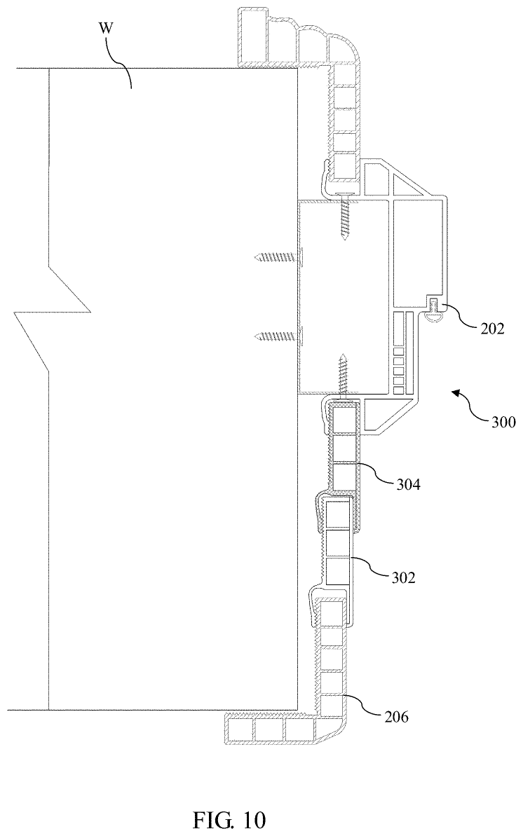

FIG. 9 is an exploded view of a door frame combination structure according to a second embodiment of the present invention. FIG. 10 is a schematic diagram of the door frame combination structure according to the second embodiment of the present invention. The difference between the second embodiment in FIG. 9 and FIG. 10 and the first embodiment in FIG. 5 to FIG. 8 is that in FIG. 9 and FIG. 10, two extended decoration boards 302 and 304 are combined with the door frame body 202 and the external decoration board 206 to form a door frame 300 to be installed on the wall W. The extended decoration boards 302 and 304 in the second embodiment are identical to the extended decoration board 204 in the first embodiment in structure, the door frame body 202 and the external decoration board 206 in the second embodiment are identical to the door frame body 202 and the external decoration board 206 in the first embodiment in structure, and the descriptions are omitted herein.

As the thickness of the wall W of a house gradually increases, only the number of extended decoration boards for the door frame needs to be increased, and the size of the extended decoration board or the external decoration board does not need to be changed, thereby avoiding the huge inventory pressure caused by the manufacture of door frames with various sizes.

The mode of forming the door frame 300 by combining the two extended decoration boards 302 and 304 with the door frame body 202 and the external decoration board 206 in the second embodiment is similar to the mode of forming the door frame 200 by combining the extended decoration board 204 with the door frame body 202 and the external decoration board 206 in the first embodiment, and the descriptions are omitted herein. However, the effect achieved by the door frame 300 formed by combining the two extended decoration boards 302 and 304 with the door frame body 202 and the external decoration board 206 in the second embodiment is the same as the effect achieved by the door frame 200 formed by combining the extended decoration board 204 with the door frame body 202 and the external decoration board 206 in the first embodiment, and the surface tooth buckles and the internal tooth buckles of the extended decoration boards 302 and 304 can be tightly clamped with the internal tooth buckle of the door frame body 202 and the surface tooth buckle of the external decoration board 206 respectively, so that the stability of the assembled door frame 300 installed on the wall W is enhanced.

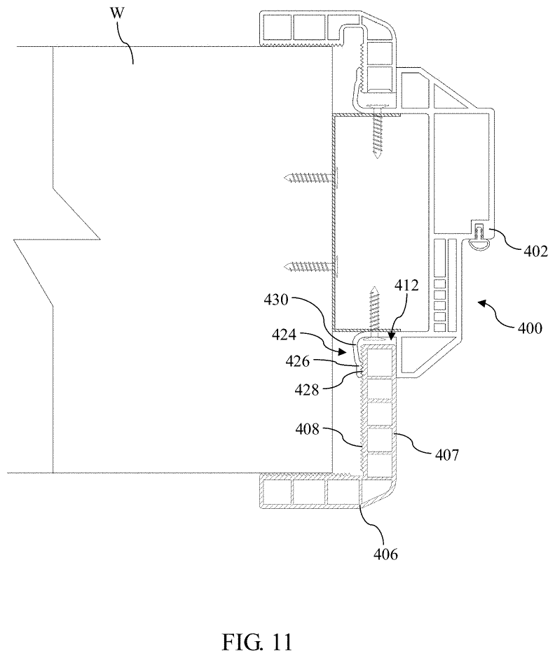

FIG. 11 is a schematic diagram of a door frame combination structure according to a third embodiment of the present invention. In the third embodiment, an external decoration board clamping surface of an external decoration board connecting arm 407 of an external decoration board 406 is provided with an external decoration board surface tooth buckle 408, where the external decoration board connecting arm 407 of the external decoration board 406 in FIG. 11 is inserted into the lower surface of a groove 412 in one end of a door frame body 402 in a horizontal direction. Because the surface of the external decoration board 406 is treated by modes of spraying paint, sticking thin rubber, sticking veneer and the like, the thickness of the external decoration board connecting arm 407 of the external decoration board 406 is increased.

The right side, or the bottom, edge of the door frame body 402 as seen in FIG. 11 (also the left side, or the top, edge of the door frame body 402, and the descriptions are omitted herein) is provided with a door frame body clamping part 424 with a C-shaped groove 412, and the internal surface of the door frame body clamping edge 426 of the door frame body clamping part 424 is provided with a door frame body internal tooth buckle 428 in the position of the opening close to the groove 412. When the external decoration board connecting arm 407 of the external decoration board 406 is inserted into the C-shaped groove 412 of the door frame body clamping part 424 of the door frame body 402, the external decoration board surface tooth buckle 408 of the external decoration board clamping surface of the external decoration board connecting arm 407 of the external decoration board 406 is clamped with the door frame body internal tooth buckle 428 of the door frame body clamping edge 426 of the door frame body 402.

The door frame body clamping edge 426 of the door frame body clamping part 424 of the door frame body 402 is designed to have elasticity, and the door frame body clamping edge 426 of the door frame body clamping part 424 is provided with a door frame body concave region 430 which is inward concave (downward concave in FIG. 11) in the position away from the opening of the groove 412. In the third embodiment, the internal diameter of the door frame body clamping part 424 in the position provided with the door frame body concave region 430 in the groove 412 is greater than the internal diameter of the door frame body clamping part 424 in the position provided with the door frame body internal tooth buckle 428 in the groove 412.

The internal diameter of the door frame body clamping part 424 of the door frame body 402 in the position of the door frame body concave region 430 of the groove 412 is designed to be equal to or greater than the thickness of the external decoration board connecting arm 407 of the external decoration board 406, and the thickness of the external decoration board connecting arm 407 of the external decoration board 406 is greater than the internal diameter of the door frame body clamping part 424 of the door frame body 402 in the position provided with the door frame body internal tooth buckle 428 in the groove 412. When the thickness of the wall W of the house is only required to combine the door frame body 402 with the external decoration board 406 into a door frame 400 to be installed on the wall W, the external decoration board connecting arm 407 of the external decoration board 406 is inserted into the groove 412 of the door frame body 402. Because the thickness of the external decoration board connecting arm 407 of the external decoration board 406 is greater than the internal diameter of the groove 412 of the door frame body 402, the opening of the door frame body clamping edge 426 of the door frame body 402 is expanded by the external decoration board connecting arm 407 of the external decoration board 406. However, the internal diameter of the door frame body concave region 430 of the groove 412 of the door frame body 402 is equal to or greater than the thickness of the external decoration board connecting arm 407 of the external decoration board 406, and the door frame body clamping edge 426 of the door frame body clamping part 424 of the door frame body 402 has elasticity, so that the door frame body clamping edge 426 of the door frame body clamping part 424 of the door frame body 402 is expanded by the external decoration board connecting arm 407 of the external decoration board 406 but is not downward skewed. The door frame body internal tooth buckle 428 of the door frame body clamping edge 426 of the door frame body 402 can be tightly clamped with the external decoration board surface tooth buckle 408 of the external decoration board connecting arm 407 of the external decoration board 406, so that the stability of the assembled door frame 400 installed on the wall W is enhanced.

The present invention provides the extendable wall-enclosed door frame which is characterized in that the internal surfaces of the grooves of the door frame body and the extended decoration board are respectively provided with tooth buckles, the external surfaces of the connecting arms of the extended decoration board and the external decoration board are provided with tooth buckles, and the internal diameters of the concave regions of the openings of the grooves of the door frame body and the extended decoration board are greater than the thicknesses of the connecting arms of the extended decoration board and the external decoration board. When the connecting arm of the external decoration board is inserted into the groove of the door frame body, the clamping edge of the door frame body positioned in the groove cannot be expanded and skewed by the connecting arm of the external decoration board, and the tooth buckles of the connecting arms of the extended decoration board and the external decoration board are tightly clamped with the tooth buckles of the grooves of the door frame body and the extended decoration board respectively, thereby enhancing the stability of the assembled door frame.

The present invention is described above with reference to preferred embodiments and exemplary drawings, and the present invention shall not be limited thereto. Any modification, omission, and change made, about aspects and embodiment content of the present invention, by a person skilled in the prior art shall fall within the claimed scope of the applied patent scope.

### LIST OF REFERENCE NUMERALS

10 Door frame

12 External decoration board

12′ External decoration board

14 Door frame body

16 Groove

18 Internal tooth buckle

19 Clamping edge

20 Door frame

22 External decoration board

23 Connecting arm

24 Door frame body

26 Groove

28 Extended decoration board

28′ Extended decoration board

30 Connecting arm

30′ Connecting arm

32 Groove

32′ Groove

122 Connecting arm

122′ Connecting arm

124 Surface tooth buckle

200 Door frame

202 Door frame body

204 Extended decoration board

205 Extended decoration board connecting arm

206 External decoration board

207 External decoration board connecting arm

208 External decoration board surface tooth buckle

210 Groove

212 Groove

214 Extended decoration board surface tooth buckle

216 Extended decoration board clamping part

218 Extended decoration board clamping edge

220 Extended decoration board internal tooth buckle

222 Extended decoration board concave region

224 Door frame body clamping part

226 Door frame body clamping edge

228 Door frame body internal tooth buckle

230 Door frame body concave region

300 Door frame

302 Extended decoration board

304 Extended decoration board

400 Door frame

402 Door frame body

406 External decoration board

407 External decoration board connecting arm

408 External decoration board surface tooth buckle

412 Groove

424 Door frame body clamping part

426 Door frame body clamping edge

428 Door frame body internal tooth buckle

430 Door frame body concave region

D1 Internal diameter

D2 Internal diameter

D3 Thickness

D4 Thickness

D5 Internal diameter

D6 Internal diameter

W Wall

What is claimed is:

1. An extendable wall-enclosed door frame, comprising:
an external decoration board, wherein an external decoration board clamping surface of the external decoration board is provided with an external decoration board surface tooth buckle;
at least one extended decoration board, wherein an extended decoration board clamping surface of the extended decoration board is provided with an extended decoration board surface tooth buckle, one end of the extended decoration board is provided with an extended decoration board clamping part with a C-shaped groove, an extended decoration board clamping edge of the extended decoration board clamping part is provided with an extended decoration board internal tooth buckle, and when the external decoration board is inserted into the C-shaped groove of the extended decoration board clamping part of the at least one extended decoration board, the external decoration board surface tooth buckle of the external decoration board clamping surface of the external decoration board is clamped with the extended decoration board internal tooth buckle of the extended decoration board clamping edge of the extended decoration board clamping part of the at least one extended decoration board; and
a door frame body, wherein each of two side edges of the door frame body is respectively provided with a door frame body clamping part with a C-shaped groove, a door frame body clamping edge of the door frame body clamping part is provided with a door frame body internal tooth buckle, and when the at least one extended decoration board is inserted into the C-shaped groove of the door frame body clamping part of the door frame body, the extended decoration board surface tooth buckle of the extended decoration board clamping surface of the at least one extended decoration board is clamped with the door frame body internal tooth buckle of the door frame body clamping edge of the door frame body clamping part of the door frame body,
the door frame body clamping edge of the door frame body clamping part and the extended decoration board clamping edge of the extended decoration board clamping part have elasticity, the door frame body clamping edge of the door frame body clamping part and the extended decoration board clamping edge of the extended decoration board clamping part are respectively provided with the door frame body internal tooth buckle and the extended decoration board internal tooth buckle in the positions of the openings close to the C-shaped grooves, the door frame body clamping edge of the door frame body clamping part and the extended decoration board clamping edge of the extended decoration board clamping part are respectively provided with a door frame body concave region and an extended decoration board concave region which are inward concave in the positions away from the openings of the C-shaped grooves, the internal diameter of the door frame body clamping part in the position provided with the door frame body concave region in the C-shaped groove is greater than the internal diameter of the door frame body clamping part in the position provided with the door frame body internal tooth buckle in the C-shaped groove, and the internal diameter of the extended decoration board clamping part in the position provided with the extended decoration board concave region in the C-shaped groove is greater than the internal diameter of the extended decoration board clamping part in the position provided with the extended decoration board internal tooth buckle in the C-shaped groove.

2. The extendable wall-enclosed door frame according to claim 1, wherein the internal diameter of the extended decoration board clamping part in the position provided with the extended decoration board concave region in the C-shaped groove is equal to or greater than the thickness of an external decoration board connecting arm of the external decoration board, and the internal diameter of the door frame body clamping part in the position provided with the door frame body concave region in the C-shaped groove is equal to or greater than the thickness of an extended decoration board connecting arm of the at least one extended decoration board.

3. The extendable wall-enclosed door frame according to claim 1, wherein the at least one extended decoration board comprises a first extended decoration board and a second extended decoration board,
a first extended decoration board clamping surface of the first extended decoration board is provided with a first extended decoration board surface tooth buckle, one end of the first extended decoration board is provided with a first extended decoration board clamping part with a C-shaped groove, a first extended decoration board clamping edge of the first extended decoration board clamping part is provided with a first extended decoration board internal tooth buckle, and when the external decoration board is inserted into the C-shaped groove of the first extended decoration board clamping part of the first extended decoration board, the external decoration board surface tooth buckle of the external decoration board clamping surface of the external decoration board is clamped with the first extended decoration board internal tooth buckle of the first extended decoration board clamping edge of the first extended decoration board clamping part of the first extended decoration board;
a second extended decoration board clamping surface of the second extended decoration board is provided with a second extended decoration board surface tooth buckle, one end of the second extended decoration board is provided with a second extended decoration board clamping part with a C-shaped groove, a second extended decoration board clamping edge of the second extended decoration board clamping part is provided with a second extended decoration board internal tooth buckle, and when the first extended decoration board is inserted into the C-shaped groove of the second extended decoration board clamping part of the second extended decoration board, the first extended decoration board surface tooth buckle of the first extended decoration board clamping surface of the first extended decoration board is clamped with the second extended decoration board internal tooth buckle of the second extended decoration board clamping edge of the second extended decoration board clamping part of the second extended decoration board; and
when the second extended decoration board is inserted into the C-shaped groove of the door frame body clamping part of the door frame body, the second extended decoration board surface tooth buckle of the second extended decoration board clamping surface of the second extended decoration board is clamped with the door frame body internal tooth buckle of the door frame body clamping edge of the door frame body clamping part of the door frame body.

4. An extendable wall-enclosed door frame, comprising:
an external decoration board, wherein an external decoration board clamping surface of the external decoration board is provided with an external decoration board surface tooth buckle; and
a door frame body, wherein each of two side edges of the door frame body is respectively provided with a door frame body clamping part with a C-shaped groove, a door frame body clamping edge of the door frame body clamping part is provided with a door frame body internal tooth buckle, and when the external decoration board is inserted into the C-shaped groove of the door frame body clamping part of the door frame body, the external decoration board surface tooth buckle of the external decoration board clamping surface of the external decoration board is clamped with the door frame body internal tooth buckle of the door frame body clamping edge of the door frame body clamping part of the door frame body,
the door frame body clamping edge of the door frame body clamping part has elasticity, the door frame body clamping edge of the door frame body clamping part is provided with the door frame body internal tooth buckle in the position of the opening close to the C-shaped groove, the door frame body clamping edge of the door frame body clamping part is provided with a door frame body concave region which is inward concave in the position away from the opening of the C-shaped groove, and the internal diameter of the door frame body clamping part in the position provided with the door frame body concave region in the C-shaped groove is greater than the internal diameter of the door frame body clamping part in the position provided with the door frame body internal tooth buckle in the C-shaped groove.

5. The extendable wall-enclosed door frame according to claim 4, wherein the internal diameter of the door frame body clamping part in the position provided with the door frame body concave region in the C-shaped groove is equal to or greater than the thickness of an external decoration board connecting arm of the external decoration board.
